(19) United States
(12) Patent Application Publication
(10) Pub. No.: US 2025/0391363 A1
(43) Pub. Date: Dec. 25, 2025

(54) PIXEL, DISPLAY DEVICE INCLUDING THE SAME, AND ELECTRONIC DEVICE INCLUDING THE SAME

(71) Applicant: Samsung Display Co., LTD., Yongin-si (KR)

(72) Inventors: Jun Hyun PARK, Yongin-si (KR); Hyeong Seok KIM, Yongin-si (KR); Sun Hwa LEE, Yongin-si (KR)

(21) Appl. No.: 19/211,840

(22) Filed: May 19, 2025

(30) Foreign Application Priority Data
Jun. 20, 2024 (KR) 10-2024-0080137
Nov. 25, 2024 (KR) 10-2024-0169527

(51) Int. Cl. G09G 3/3233; G09G 3/32

(52) U.S. Cl. CPC G09G 3/3233; G09G 3/32; G09G 2300/0426; G09G 2310/08

(57) ABSTRACT

A pixel includes a first transistor including a gate electrode connected to a first node, where the first transistor is connected between a first power line and a second node, a second transistor including a gate electrode connected to an i-th scan line, where the second transistor is connected between the first node and a third node, and i is an integer equal to or greater than 1, a third transistor including a gate electrode connected to a j-th scan line, the third transistor is connected between the second node and third node, and j is an integer different from i, and a light-emitting element connected between the second node and a second power line.

This application claims priority to Korean Patent Application No. 10-2024-0080137, filed on Jun. 20, 2024, and Korean Patent Application No. 10-2024-0169527, filed on Nov. 25, 2024, and all the benefits accruing therefrom under 35 U.S.C. § 119, the contents of which in their entireties are herein incorporated by reference.

### BACKGROUND

### 1. Field

Embodiments of the disclosure relate to a pixel, a display device including the pixel, and an electronic device including the pixel.

### 2. Description of the Related Art

With the development of information technology, the importance of a display device, which is a connection medium between a user and information, is being highlighted. Accordingly, the use of display devices such as liquid crystal display devices and organic light emitting display devices is increasing.

In a high-resolution display device, the degree of integration of pixels may be desired to increase.

### SUMMARY

Embodiments of the disclosure provide a pixel having an improved or increased degree of integration, a display device including the pixel, and an electronic device including the pixel.

Embodiments of the disclosure provide a pixel including a first transistor including a gate electrode connected to a first node, where the first transistor is connected between a first power line and a second node, a second transistor including a gate electrode connected to an i-th scan line, where the second transistor is connected between the first node and a third node, and i is an integer equal to or greater than 1, a third transistor including a gate electrode connected to a j-th scan line, where the third transistor is connected between the second node and the third node, and j is an integer different from i, a light-emitting element connected between the second node and a second power line, a first capacitor including a first electrode connected to the first node and a second electrode connected to a third power line, and a second capacitor including a first electrode connected to the third node and a second electrode connected to a data line.

In an embodiment, j may be an integer greater than i.

In an embodiment, j may be equal to (i+1).

In an embodiment, the first to third transistors may be P-type transistors.

In an embodiment, a first power supply voltage may be applied to the first power line, a second power supply voltage may be applied to the second power line, a third power supply voltage may be applied to the third power line, an i-th scan signal may be applied to the i-th scan line, and the (i+1)-th scan signal may be applied to the j-th scan line. In such an embodiment, each of the first to third power supply voltages may have a varying voltage level.

In an embodiment, in a first period of a frame period, the first power supply voltage may have a first voltage at a high level, the second power supply voltage may have a third voltage at a high level, the third power supply voltage may have a sixth voltage at a low level, the i-th scan signal may have an off level, and the (i+1)-th scan signal may have the off level.

In an embodiment, in the second period of a frame period, the first power supply voltage may have a second voltage at a low level, the second power supply voltage may have a third voltage at a high level, the third power supply voltage may have a sixth voltage at a low level, the i-th scan signal may transition to the on level, the (i+1)-th scan signal may transition to the on level, and the first to third nodes may be electrically connected to each other.

In an embodiment, in a third period of a frame period, the first power supply voltage may have a first voltage at a high level, the second power supply voltage may have a third voltage at a high level, the third power supply voltage may have a fifth voltage at a high level, the i-th scan signal may have an on level, the (i+1)-th scan signal may have the on level, and the first power line may be electrically connected to the first node through the second and third nodes.

In an embodiment, in at least a part of a fourth period of a frame period, the first power supply voltage may have a second voltage at a low level, the second power supply voltage may have a third voltage at a high level, the third power supply voltage may have a fifth voltage at a high level, the i-th scan signal may have an on level, the (i+1)-th scan signal may have an off level, and the first node and the third node may be electrically connected to each other.

In an embodiment, in a remaining part of the fourth period of the frame period, the first power supply voltage may have a second voltage, the second power supply voltage may have a third voltage, the third power supply voltage may have a fifth voltage, the i-th scan signal may have the off level, the (i+1)-th scan signal may have the on level, and the second node and the third node may be electrically connected to each other.

In an embodiment, in a fifth period of a frame period, the first power supply voltage may have a second voltage at a low level, the second power supply voltage may transition to a fourth voltage at a low level, the third power supply voltage may transition to a sixth voltage at a low level, the i-th scan signal may have an off level, and the (i+1)-th scan signal may have the off level.

In an embodiment, in a sixth period, the first power supply voltage may have a first voltage at a high level, the second power supply voltage may have a fourth voltage at a low level, the third power supply voltage may have a fifth voltage at a high level, the i-th scan signal may have an off level, the (i+1)-th scan signal may have an off level, and a driving current may flow through the light-emitting element.

In an embodiment, semiconductor layers of the first transistor and the third transistor may be defined by a first active pattern, and a semiconductor layer of the second transistor may be defined by a second active pattern spaced apart from the first active pattern.

Embodiments of the disclosure provide a display device including a display panel including a plurality of pixels and a plurality of scan lines connected to the plurality of pixels, and a scan driving circuit which supplies a scan signal to the plurality of scan lines, respectively, where a pixel of the plurality of pixels includes a first transistor including a gate electrode connected to a first node, where the first transistor is connected between a first power line and a second node, a second transistor including a gate electrode connected to an i-th scan line of the plurality of scan lines, where the second transistor is connected between the first node and a third node, and i is an integer equal to or greater than 1, a third transistor including a gate electrode connected to a j-th scan line of the plurality of scan lines, and j is an integer different from i, where the transistor is connected between the second node and the third node, a light-emitting element connected between the second node and a second power line, a first capacitor including the first electrode connected to the first node and a second electrode connected to a third power line, and a second capacitor including a first electrode connected to the third node and a second electrode connected to a data line.

In an embodiment, j may be equal to (i+1).

In an embodiment, the plurality of pixels may include pixels located in an i-th pixel row, and the pixels located in the i-th pixel row may be connected to both the i-th scan line and an (i+1)-th scan line.

In an embodiment, the display device may further include a power supply circuit which supplies a first power supply voltage, a second power supply voltage, and a third power supply voltage to the first power line, the second power line, and the third power line, respectively. In such an embodiment, the power supply circuit may change a voltage level of each of the first power supply voltage, the second power supply voltage, and the third power supply voltage between at least two levels.

Embodiments of the disclosure provide a display device, including a display panel including a plurality of pixels, a plurality of scan lines connected to the plurality of pixels, and a plurality of data lines connected to the plurality of pixels, a scan driving circuit which supplies a scan signal to the plurality of scan lines, and a data driving circuit which supplies a data voltage to the plurality of data lines, where a first pixel of the plurality of pixels is connected to an i-th scan line of the plurality of scan lines, an (i+1)-th scan line of the plurality of scan lines, and a j-th data line of the plurality of data lines, where i is an integer equal to or greater than 1, and j is an integer equal to or greater than 1, where a second pixel of the plurality of pixels is connected to the i-th scan lines, the (i+1)-th scan lines, and a (j+1)-th data line of the plurality of data lines, where a third pixel of the plurality of pixels are connected to the (i+1)-th scan line, the (i+2)-th scan line, and the j-th data line, where a fourth pixel of the plurality of pixels is connected to the (i+1)-th scan line, the (i+2)-th scan line, and the (j+1)-th data line, where the first pixel and the second pixel receive corresponding data voltage in response to a scan signal supplied to the i-th scan line, and where the third pixel and the fourth pixel receive corresponding data voltage in response to a scan signal supplied to the (i+1)-th scan line.

In an embodiment, the first pixel may include a first transistor including a gate electrode connected to a first node, where the first transistor is connected between a first power line and a second node, a second transistor including a gate electrode connected to the i-th scan line, where the second transistor is connected between the first node and a third node, a third transistor including a gate electrode connected to the (i+1)-th scan line, where the third transistor is connected between the second node and the third node, a light-emitting element connected between the second node and a second power line, a first capacitor including the first electrode connected to the first node and the second electrode connected to a third power line, and a second capacitor including a first electrode connected to the third node and a second electrode connected to the j-th data line.

Embodiments of the disclosure provide an electronic device including a host which provides input image data, and a display device including a plurality of pixels for displaying an image based on the input image data, and a plurality of scan lines connected to the plurality of pixels, where a pixel of the plurality of pixels includes a first transistor including a gate electrode connected to a first node, where the first transistor is connected between a first power line and a second node, a second transistor including a gate electrode connected to an i-th scan line of the plurality of scan lines, where the second transistor is connected between the first node and a third node, and i is an integer equal to or greater than 1, a third transistor including a gate electrode connected to an (i+1)-th scan line of the plurality of scan lines, where the third transistor is connected between the second node and the third node, a light-emitting element connected between the second node and a second power line, a first capacitor including the first electrode connected to the first node and a second electrode connected to a third power line, and a second capacitor including a first electrode connected to the third node and a second electrode connected to a data line.

### BRIEF DESCRIPTION OF THE DRAWINGS

The above and other features of the disclosure will become more apparent by describing in further detail embodiments thereof with reference to the accompanying drawings, in which:

FIG. 1 is a system block diagram of a display device according to embodiments of the disclosure;

FIG. 2 is an equivalent circuit diagram of a pixel according to embodiments of the disclosure;

FIG. 3 is a schematic diagram of a connection relationship between pixels and scan lines in embodiments of the disclosure;

FIGS. 4 to 18 are diagrams illustrating a stacked-layer structure of a display panel;

FIG. 19 is a signal timing diagram illustrating a method of driving a display device according to embodiments of the disclosure;

FIGS. 20 to 26 are diagrams illustrating a method of driving the display device according to FIG. 19 with the pixel of FIG. 2;

FIG. 27 is a diagram illustrating an embodiment of a display system according to embodiments of the disclosure;

FIG. 28 is a diagram showing an application example of the display system of FIG. 27;

FIG. 29 is a diagram showing a head-mounted display device worn by a user;

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In order to clearly explain the invention, parts not related to the description may be omitted, and the same or similar components are denoted by the same reference numerals throughout the specification. Accordingly, the aforementioned reference numerals may also be used in other drawings.

In addition, the size and thickness of each component shown in the drawings are arbitrarily shown for convenience of description, and therefore, the invention is not necessarily limited to what is shown. Thicknesses may be exaggerated to clearly represent multiple layers and regions in the drawings.

The expression “same” in the description may mean “substantially the same”. In other words, it may be the same enough that a person with ordinary knowledge can understand that they are the same. Other expressions may also be those in which “substantially” is omitted.

It will be understood that when an element is referred to as being “on” another element, it can be directly on the other element or intervening elements may be present therebetween. In contrast, when an element is referred to as being “directly on” another element, there are no intervening elements present.

The terms first, second, etc. may be used to describe various components, but the components should not be limited by the terms. The above terms are used only for the purpose of distinguishing one component from another. For example, a first component may be named a second component, and similarly, a second component may also be named a first component, without departing from the scope of the invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. In addition, terms such as those defined in commonly used dictionaries should be interpreted as having a meaning that is consistent with the meaning in the context of the relevant art, and are expressly defined herein unless interpreted in an ideal or overly formal sense unless expressly so defined herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described in detail with reference to the accompanying drawings.

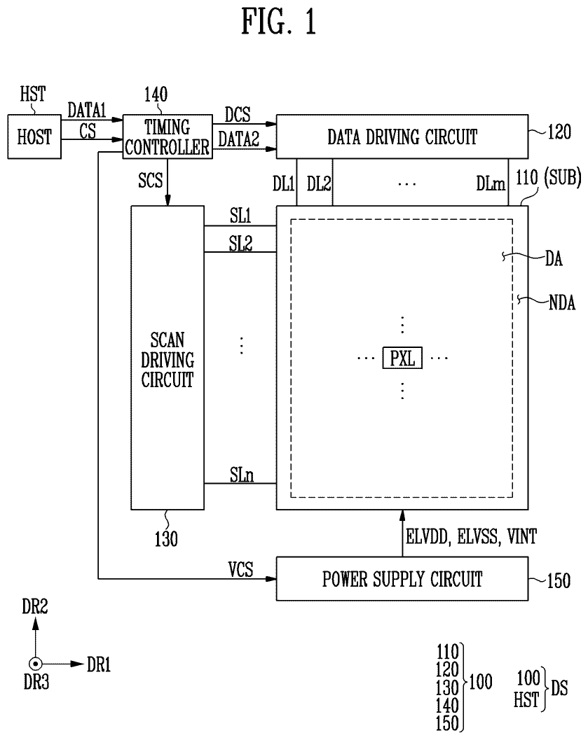

FIG. 1 is a system block diagram of a display device 100 according to embodiments of the disclosure.

Referring to FIG. 1, a display device 100 according to embodiments of the disclosure may include a display panel 110, a data driving circuit 120, a scan driving circuit 130, a timing controller 140, a power supply circuit 150, or the like.

The display panel 110 may include a substrate SUB. The display panel 110 may include a display area DA in which a plurality of pixels PXL are disposed on the substrate SUB, and a non-display area NDA around the display area DA. A plurality of data lines DL1 to DLm (m is an integer of 2 or greater) and a plurality of scan lines SL1 to SLn (n is an integer of two or greater) electrically connected to a plurality of pixels PXL may be disposed on the display panel 110 (or in the display area DA). One or more power lines configured to apply a power supply voltage to a plurality of pixels PXL may be disposed on the display panel 110. The non-display area NDA may be located in an area around the display area DA (e.g., an edge area of the display area DA). One or more pads may be disposed in the non-display area NDA, and a data voltage, a power supply voltage, and the like may be supplied to a plurality of data lines DL1 to DLm and the power lines through the pads.

The display panel 110 may be flat, but embodiments of the disclosure are not limited thereto. In an embodiment, for example, the display panel 110 may include curved portions formed at left and right ends. A curved surface may have a constant curvature or a varying curvature. In addition, the display panel 110 may be flexibly formed to be curved, bent, folded, or rolled.

In an embodiment, the substrate SUB may include a rigid glass substrate. However, embodiments of the disclosure are not limited thereto, and may include a plastic substrate having flexibility. In an embodiment, for example, the plastic substrate may be implemented as (or defined by) a polyimide (PI) substrate. In another embodiment, the substrate SUB may be implemented as a silicon substrate.

A plurality of data lines DL1 to DLm may extend in one direction (for example, the second direction DR2) in the display panel 110. The plurality of data lines DL1 to DLm may be disposed to extend from the display panel 110 in the second direction DR2 (e.g., generally in the second direction DR2). The second direction DR2 may be, for example, a direction from the upper side to the lower side of the display panel 110, but embodiments of the disclosure are not limited thereto.

The plurality of scan lines SL1 to SLn may extend in one direction (for example, the first direction DR1) from the display panel 110. The plurality of scan lines SL1 to SLn may be disposed to extend from the display panel 110 in the first direction DR1 (e.g., generally in the first direction DR1). The first direction DR1 may be a direction different from the second direction DR2, but embodiments of the disclosure are not limited thereto. The first direction DR1 may be, for example, a direction from the left to the right of the display panel 110.

The data driving circuit 120 may be configured to supply a data voltage to a plurality of data lines DL1 to DLm. The data driving circuit 120 may generate a data voltage based on the second image data DATA2 and the data driving circuit control signal DCS, and output the generated data voltage to the plurality of data lines DL1 to DLm according to timing. The data driving circuit control signal DCS may include, for example, a source start pulse (SSP) signal, a source shift clock (SSC) signal, or a source output enable (SOE) signal.

The data driving circuit 120 may be implemented as an integrated circuit (e.g., a source driving integrated circuit (SDIC)) formed separately from the display panel 110, or may be formed together with the display panel 110 and formed in at least a part of a non-display area NDA of the display panel 110.

The scan driving circuit 130 is configured to output scan signals to the plurality of scan lines SL1 to SLn in response to the scan driving circuit control signal SCS. The scan driving circuit control signal SCS may include a start signal indicating the start of the frame, a horizontal synchronization signal for outputting the scan signal in accordance with the timing at which the data voltage is applied, or the like.

The scan driving circuit 130 may be implemented as an integrated circuit (e.g., a gate driving integrated circuit (GDIC)) formed separately from the display panel 110, or may be formed together with the display panel 110 and formed in at least a part of a non-display area NDA of the display panel 110.

The power supply circuit 150 may be configured to output a constant voltage at a constant voltage level. The power supply circuit 150 may output a power supply voltage (for example, the first power supply voltage ELVDD, the second power supply voltage ELVSS, and the third power supply voltage VINT) supplied to the display panel 110. According to an embodiment, the power supply circuit 150 may output a voltage (e.g., a gate high voltage, a gate low voltage, or the like) supplied to the scan driving circuit 130. According to an embodiment, the power supply circuit 150 may output a voltage (e.g., a gamma voltage or the like) supplied to the data driving circuit 120. The power supply circuit 150 may include, for example, a regulator (e.g., a low dropout (LDO) regulator). The power supply circuit 150 may be implemented as, for example, a power management integrated circuit (PMIC). The power supply circuit 150 may be configured to output a power supply voltage to the power lines in response to the power supply circuit control signal VCS.

The timing controller 140 may be configured to control the data driving circuit 120, the scan driving circuit 130, the power supply circuit 150, or the like. The timing controller 140 may generate and output control signals DCS, SCS, and VCS for controlling the data driving circuit 120, the scan driving circuit 130, and the power supply circuit 150 based on the control signal CS (e.g., a synchronization signal, a clock signal, a data enable signal, or the like.) received through the host HST. According to an embodiment, the timing controller 140 may generate a synchronization signal, a data enable signal, or the like therein based on the control signal CS (for example, information on the driving frequency (or frame rate) of the image displayed on the display panel 110) received through the host HST.

The timing controller 140 may receive first image data (or input image data) DATA1 from a host HST and sort the input first image data DATA1 in pixel row units. The timing controller 140 may convert the input first image data DATA1 according to an interface (e.g., a preset interface) such as Low Voltage Differential Signaling (LVDS), Display Port (DP), embedded Display Port (eDP), or the like. The second image data DATA2 output from the timing controller 140 to the data driving circuit 120 may be converted inside the timing controller 140 according to the preset interface.

According to an embodiment, the timing controller 140 may be disposed in the display device 100 in a logic type. According to an embodiment, the timing controller 140 may be disposed in the display device 100 in a processor type. Timing controller 140 may include one or more memories (e.g., registers, or the like.).

The electronic device DS according to embodiments of the disclosure may include a display device 100 and the host HST.

The host HST may be implemented as a set-top box, an application processor (AP), or the like. In an embodiment, the host HST may be configured outside the display device 100 and is not included within the display device 100. In an embodiment, the host HST may be mounted in the display device 100. Transmission and reception of the first image data DATA1 and the control signal CS may be performed through an interface between the host HST and the display device 100. The interface may be, for example, Serial Programming Interface (SPI), Inter Integrated Circuit (I2), Mobile Industry Processor Interface (MIPI), or the like. However, embodiments of the disclosure are not limited thereto.

In FIG. 1, circuits that supply signals, voltages, and the like to the display panel 110 are merely classified according to functions. In an embodiment, for example, the data driving circuit 120 and the timing controller 140 may be formed in one integrated circuit. The data driving circuit 120 and the timing controller 140 may be classified according to functions (or blocks) in one integrated circuit in the display device 100.

The display device 100 according to embodiments of the disclosure may be used as a display screen of various products such as a mobile phone, a smart phone, a tablet personal computer, and a portable electronic device such as a smart watch, a watch phone, a mobile communication terminal, an electronic notebook, an electronic book, a portable multimedia player (PMP), navigation, and an ultra-mobile personal computer (UMPC), as well as a television, a laptop, a monitor, an advertisement board, and an Internet of Things (IoT) device.

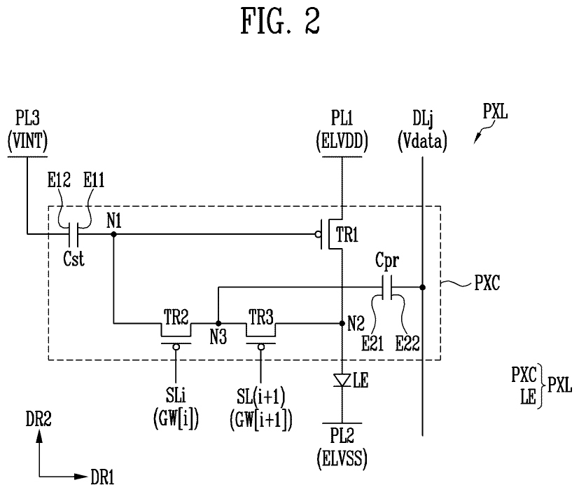

FIG. 2 is an equivalent circuit diagram of a pixel PXL according to embodiments of the disclosure.

Referring to FIG. 2, a pixel PXL according to embodiments of the disclosure may include a pixel circuit PXC and a light-emitting element LE.

The pixel circuit PXC may include two or more switching elements and one or more storage elements. In an embodiment, the switching element may include or be defined by a transistor. In an embodiment, the storage element may include or be defined by a capacitor. Referring to FIG. 2, an embodiment of a pixel circuit PXC according to embodiments of the disclosure includes three transistors and two capacitors is illustrated. However, the embodiments of the disclosure are not limited thereto, and the pixel circuit PXC may be freely selected or variously modified according to the selection of a person skilled in the art. An embodiment in which the pixel circuit PXC includes three transistors and two capacitors will be described below as an example.

Referring to FIG. 2, the pixel circuit PXC according to embodiments of the disclosure may include first to third transistors TR1 to TR3 and first and second capacitors Cst and Cpr.

The first transistor TR1 may include a gate electrode connected to the first node N1, a first electrode connected to a first power line PL1, and a second electrode connected to the second node N2. The first electrode may be one of a source electrode and a drain electrode (e.g., the source electrode). The second electrode may be the other of the source electrode and the drain electrode (e.g., the drain electrode). The first power supply voltage ELVDD may be applied to the first power line PL1. The first transistor TR1 may be configured to provide a current (e.g., a driving current) corresponding to a voltage level applied to the first node N1. The first transistor TR1 may be referred to as a driving transistor.

The second transistor TR2 may be configured to switch the electrical connection between the first node N1 and the third node N3 in response to the i-th scan signal GW[i] (i is an integer equal to or greater than 1). The second transistor TR2 may include a gate electrode connected to the i-th scan line SLi. The i-th scan signal GW[i] may be applied to the i-th scan line SLi. The second transistor TR2 may electrically connect the first node N1 and the third node N3 to each other in response to the i-th scan signal GW[i] at a turn-on level.

The third transistor TR3 may include a gate electrode connected to a scan line different from the i-th scan line SLi. In an embodiment, for example, the third transistor TR3 may include a gate electrode connected to an (i+1)-th scan line SL(i+1). In such an embodiment, the third transistor TR3 may be configured to control or switch the electrical connection between the second node N2 and the third node N3 in response to the (i+1)-th scan signal GW[i+1]. The (i+1)-th scan signal GW[i+1] may be applied to the (i+1)-th scan line SL(i+1). The third transistor TR3 may electrically connect the second node N2 and the third node N3 to each other in response to the (i+1)-th scan signal GW[i+1] at a turn-on level.

The first capacitor Cst may include a first electrode E11 connected to the first node N1 and a second electrode E12 connected to the third power line PL3. A third power supply voltage VINT may be applied to the third power line PL3. The first electrode E11 and the second electrode E12 may be disposed to face each other by an area (for example, to face each other in a vertical direction by a predetermined area). The first capacitor Cst may be configured to maintain a potential difference between the third power line PL3 and the first node N1. The first capacitor Cst may be referred to as a storage capacitor Cst.

The second capacitor Cpr may include a first electrode E21 connected to the third node N3 and a second electrode E22 electrically connected (or coupled) to the j-th data line DLj (j is an integer equal to or greater than 1). A data voltage Vdata may be applied to the j-th data line DLj. The first electrode E21 and the second electrode E22 may be disposed to face each other by an area (for example, to face each other in a vertical direction by a predetermined area). The second capacitor Cpr may be configured to maintain a potential difference between the j-th data line DLj and the third node N3. The second capacitor Cpr may be referred to as a hold capacitor Cpr.

The light-emitting element LE may be connected between the second node N2 and the second power line PL2. A second power supply voltage ELVSS may be applied to the second power line PL2. The light-emitting element LE may include a first electrode (e.g., an anode electrode) connected to the second node N2 and a second electrode (e.g., a cathode electrode) connected to a second power line PL2. A light-emitting layer may be disposed between the first electrode and the second electrode. According to an embodiment, the light-emitting layer may be implemented as an organic light-emitting layer including or be formed of an organic light-emitting material. However, the embodiments of the disclosure are not limited thereto, and the light-emitting layer may include an inorganic light-emitting material, a quantum dot, a nanorod, or the like.

Referring to FIG. 2, all of the first to third transistors TR1 to TR3 may be implemented as P-type transistors, i.e., transistors including a P-type semiconductor. Accordingly, the first to third transistors TR1 to TR3 may be turned on in response to the low level voltage, and may be turned off in response to the high level voltage. However, embodiments of the disclosure are not limited thereto, and at least one of the first to third transistors TR1 to TR3 may be implemented as an N-type transistor, i.e., a transistor including an N-type semiconductor. A transistor including an N-type semiconductor may be turned on in response to a high level voltage and turned off in response to a low level voltage. Hereinafter, for convenience of description, an embodiment in which all of the first to third transistors TR1 to TR3 are implemented as transistors including a P-type semiconductor will be described as an example, but embodiments of the disclosure are not limited thereto.

In an embodiment, each of the first to third transistors TR1 to TR3 may be implemented as a polycrystalline silicon transistor. In an embodiment, for example, each of the first to third transistors TR1 to TR3 may include a semiconductor formed through a low temperature polycrystalline silicon (LTPS) process. However, embodiments of the disclosure are not limited thereto. In another embodiment, for example, at least one of the first to third transistors TR1 to TR3 may include an oxide semiconductor.

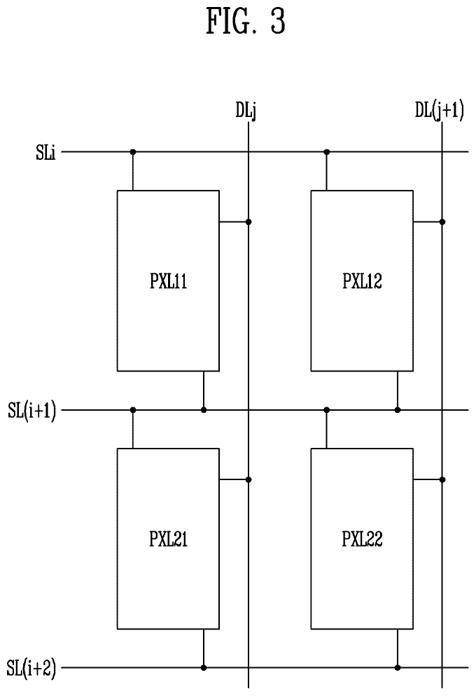

FIG. 3 is a schematic diagram of the connection relationship between the pixels PXL11 to PXL22 and the scan lines SLi to SL(i+2) in embodiments of the disclosure.

Referring to FIG. 3, an embodiment in which the first to fourth pixels PXL11 to PXL22 are arranged in two rows and two columns is shown. The i-th scan line SLi, the (i+1)-th scan line SL(i+1), and the (i+2)-th scan line SL(i+2) may each extend in the first direction DR1. The j-th data line DLj and the (j+1)-th data line DL(j+1) may each extend in the second direction DR2.

The first pixel PXL11 is located at the top left, and may be connected to the i-th scan line SLi, the (i+1)-th scan line SL(i+1), and the j-th data line DLj.

The second pixel PXL12 is located at the top right, and may be connected to the i-th scan line SLi, the (i+1)-th scan line SL(i+1), and the (j+1)-th data line DL(j+1).

The third pixel PXL21 is located at the bottom left, and may be connected to the (i+1)-th scan line SL(i+1), the (i+2)-th scan line SL(i+2), and the j-th data line DLj.

The fourth pixel PXL22 is located at the bottom right, and may be connected to the (i+1)-th scan line SL(i+1), the (i+2)-th scan line SL(i+2), and the (j+1)-th data line DL(j+1).

The first pixel PXL11 and the second pixel PXL12 may be located adjacent to each other in the first direction DR1. The third pixel PXL21 and the fourth pixel PXL22 may be located adjacent to each other in the first direction DR1.

The first pixel PXL11 and the third pixel PXL21 may be located adjacent to each other in the second direction DR2. The second pixel PXL12 and the fourth pixel PXL22 may be located adjacent to each other in the second direction DR2.

The pixel PXL (see FIG. 2) described in FIG. 2 may correspond to the first pixel PXL11 in FIG. 3.

Referring to FIG. 3, two pixels located adjacent to each other in the second direction DR2 may share one scan line or be commonly connected to a same scan line. In an embodiment, for example, the first pixel PXL11 and the third pixel PXL21 that are adjacent to each other in the second direction DR2 may share the (i+1)-th scan line SL(i+1) and may be connected in common with the (i+1)-th scan line SL(i+1).

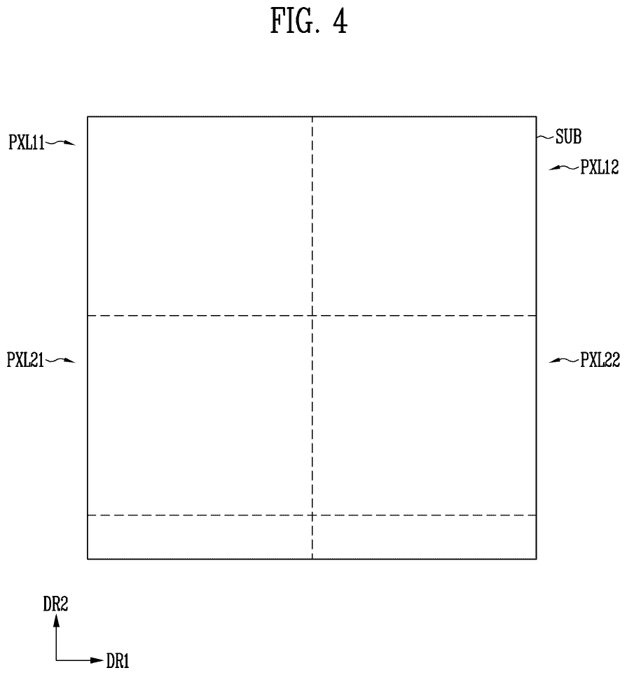

FIGS. 4 to 18 are diagrams illustrating a stacked-layer structure of the display panel 110 (see FIG. 1).

Each of the drawings will be described in greater detail below with reference to the drawings of FIGS. 4 to 18 as a whole.

Referring to FIG. 4, a substrate SUB on which a first pixel PXL11, a second pixel PXL12, a third pixel PXL21, and a fourth pixel PXL22 are disposed is illustrated. The first pixel PXL11 and the second pixel PXL12 may be located adjacent to each other in the first direction DR1 on the substrate SUB. The third pixel PXL21 and the fourth pixel PXL22 may be located adjacent to each other in the first direction DR1 on the substrate SUB. The first pixel PXL11 and the third pixel PXL21 may be located adjacent to each other in the second direction DR2 on the substrate SUB. The second pixel PXL12 and the fourth pixel PXL22 may be located adjacent to each other in the second direction DR2 on the substrate SUB.

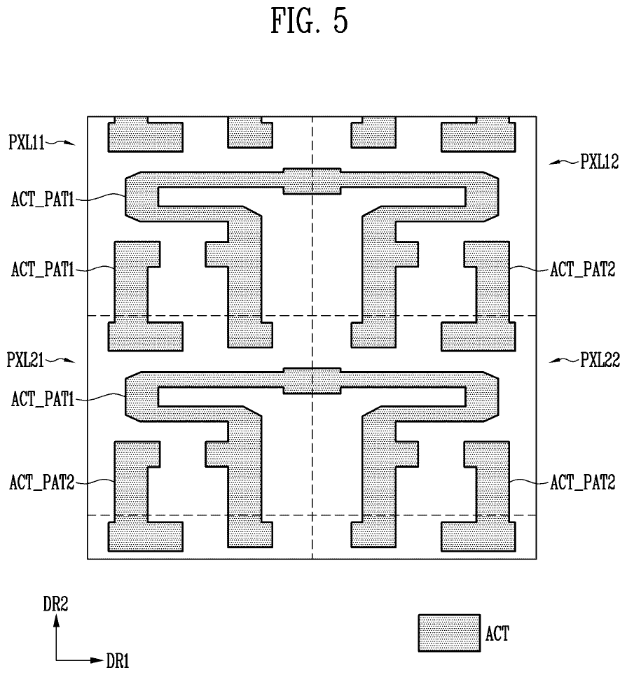

Referring to FIG. 5, an active layer ACT included in each of the transistors of the first to fourth pixels PXL11 to PXL22 is illustrated. The active layer ACT may be located on the substrate SUB. The active layer ACT may include a first active pattern ACT_PAT1 and a second active pattern ACT_PAT2. The first active pattern ACT_PAT1 and the second active pattern ACT_PAT2 may be spaced apart from each other. Each of the first to fourth pixels PXL11 to PXL22 may include or be defined by at least a part of the first active pattern ACT_PAT1 and at least a part of the second active pattern ACT_PAT2. In an embodiment, the active layer ACT may include a silicon semiconductor. In an embodiment, for example, the active layer ACT may be formed on the substrate SUB through an LTPS process. In another embodiment, for example, the active layer ACT may include a metal oxide semiconductor. The metal oxide semiconductor may include, for example, indium gallium zinc oxide (IGZO). However, embodiments of the disclosure are not limited thereto.

The active layer ACT may constitute a semiconductor layer of each of the first to third transistors TR1 to TR3 in FIG. 2 described above.

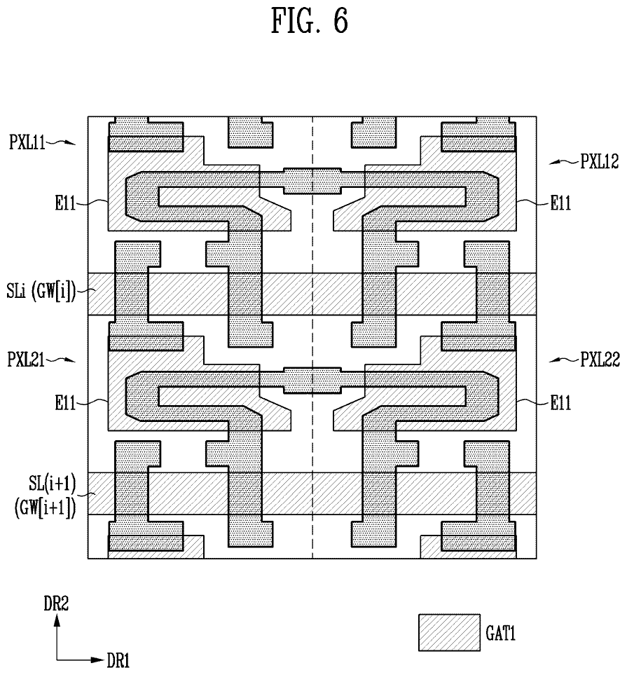

Referring to FIG. 6, a first gate electrode layer GAT1 constituting a gate electrode in each of the transistors of the first to fourth pixels PXL11 to PXL22 is illustrated. The first gate electrode layer GAT1 may be positioned on the substrate SUB.

The first gate electrode layer GAT1 may include a metal. In an embodiment, for example, the first gate electrode layer GAT1 may be include at least one selected from metals such as gold (Au), silver (Ag), aluminum (Al), molybdenum (Mo), chromium (Cr), titanium (Ti), nickel (Ni), neodymium (Nd), copper (Cu), tungsten (W), or an alloy thereof. According to an embodiment, the first gate electrode layer GAT1 may be defined by a single layer or multiple layers in which two or more of metals and alloys thereof are stacked.

A gate insulating layer may be disposed between the active layer ACT and the first gate electrode layer GAT1. The gate insulating layer may include an inorganic insulating layer including an inorganic material. The first gate insulating layer may include an inorganic insulator such as silicon oxide (SiO₂), silicon nitride (SiNₓ) (x is a positive number), silicon oxynitride (SiON), aluminum oxide (Al₂O₃), titanium oxide (TiO₂), tantalum oxide (Ta₂O₅), hafnium oxide (HfO₂), and/or zinc oxide (ZnOₓ). The zinc oxide may be zinc oxide (ZnO), and/or zinc peroxide (ZnO₂).

The first gate electrode layer GAT1 is disposed on the active layer ACT, and in response to a voltage applied to the first gate electrode layer GAT1, a channel (or a channel area) may be formed in the active layer act in an area overlapping the first gate electrode layers GAT1. The active layer ACT may further include a source region and a drain region that are spaced apart from each other with a channel region overlapping the first gate electrode layer GAT1 interposed therebetween.

Referring to FIG. 6, the i-th scan line SLi and the (i+1)-th scan line SL(i+1) may be defined by a first gate electrode layer GAT1. The i-th scan line SLi may be connected to the first to fourth pixels PXL11 to PXL22. The (i+1)-th scan line SL(i+1) may be connected to the third pixel PXL21 and the fourth pixel PXL22.

The first electrode E11 of the storage capacitor Cst (see FIG. 2) may be defined by a first gate electrode layer GAT1. The first electrode E11 may overlap the first active pattern ACT_PAT1 and the second active pattern ACT_PAT2.

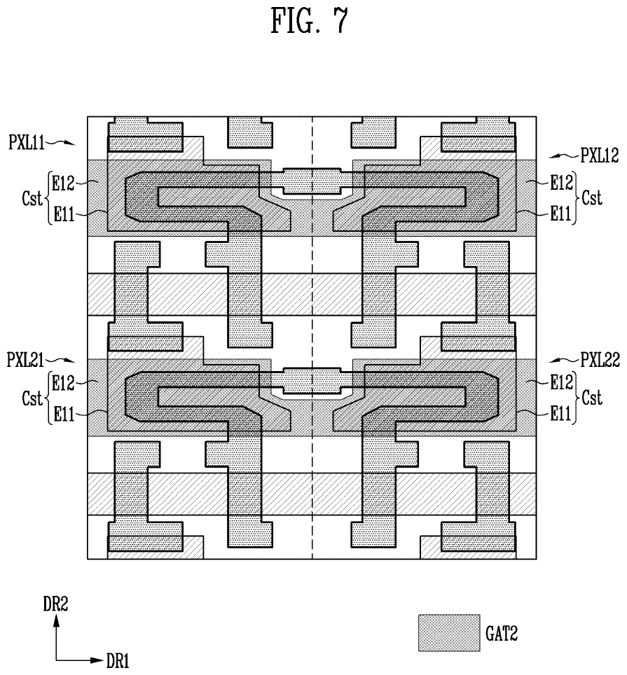

Referring to FIG. 7, the second gate electrode layer GAT2 may be disposed on the first gate electrode layer GAT1.

The second electrode E12 of the storage capacitor Cst may be defined by a second gate electrode layer GAT2. The second electrode E12 may overlap at least a part of the first electrode E11.

In an embodiment, the second electrode E12 of the storage capacitor Cst of each of the first pixel PXL11 and the second pixel PXL12 may be integrally configured as a single unitary indivisible part. However, embodiments of the disclosure are not limited thereto.

In an embodiment, the second electrode E12 of the storage capacitor Cst may overlap the first active pattern ACT_PAT1 in a plan view.

The second gate electrode layer GAT2 may include a metal. In an embodiment, for example, the second gate electrode layer GAT2 may include at least one of metals such as gold (Au), silver (Ag), aluminum (Al), molybdenum (Mo), chromium (Cr), titanium (Ti), nickel (Ni), neodymium (Nd), copper (Cu), tungsten (W), or an alloy thereof. According to an embodiment, the second gate electrode layer GAT2 may be defined by a single layer or multiple layers in which two or more of metals and alloys thereof are stacked.

At least one interlayer insulating layer may be disposed between the first gate electrode layer GAT1 and the second gate electrode layer GAT2. The interlayer insulating layer may include an inorganic insulator such as silicon oxide (SiO₂), silicon nitride (SiNₓ) (x is a positive number), silicon oxynitride (SiON), aluminum oxide (Al₂O₃), titanium oxide (TiO₂), tantalum oxide (Ta₂O₅), hafnium oxide (HfO₂), and/or zinc oxide (ZnOₓ). The zinc oxide may be zinc oxide (ZnO), and/or zinc peroxide (ZnO₂).

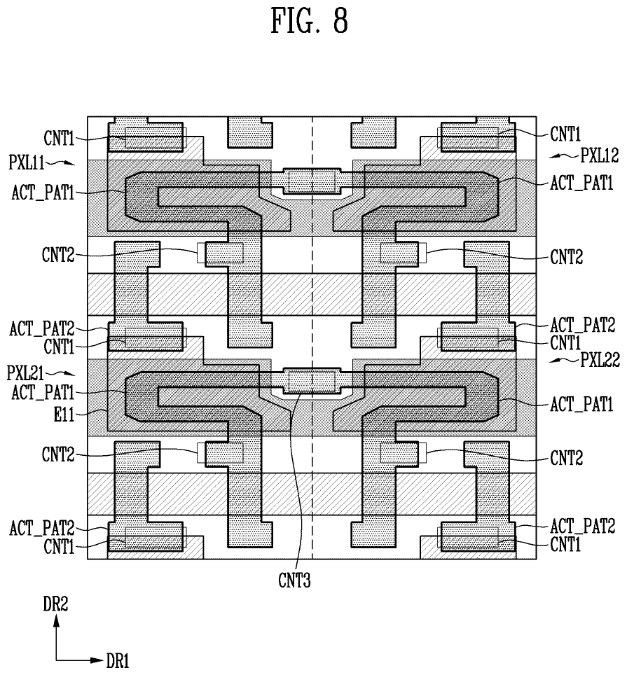

Referring to FIG. 8, a first contact hole CNT1, a second contact hole CNT2, and a third contact hole CNT3 may be disposed on the second gate electrode layer GAT2. The first to third contact holes CNT1 to CNT3 may be defined or formed by removing at least a part of the interlayer insulating layer located on the second gate electrode layer GAT2.

The first contact hole CNT1 may expose at least part of the second active pattern ACT_PAT2 and at least part of a first electrode E11 of the storage capacitor Cst.

The second contact hole CNT2 may expose at least a part of the first active pattern ACT_PAT1. In an embodiment, for example, the third pixel PXL21 may include a second contact hole CNT2, and the second contact hole CNT2 of the third pixel TXL21 may be located between the first electrode E11 of the storage capacitor Cst and the (i+1)-th scan line SL(i+1).

The third contact hole CNT3 may be located in a boundary region between two pixels adjacent to each other in the first direction DR1. In an embodiment, for example, the third contact hole CNT3 may be located between the first pixel PXL11 and the second pixel PXL12. For example, the third contact hole CNT3 may be located between the third pixel PXL21 and the fourth pixel PXL22.

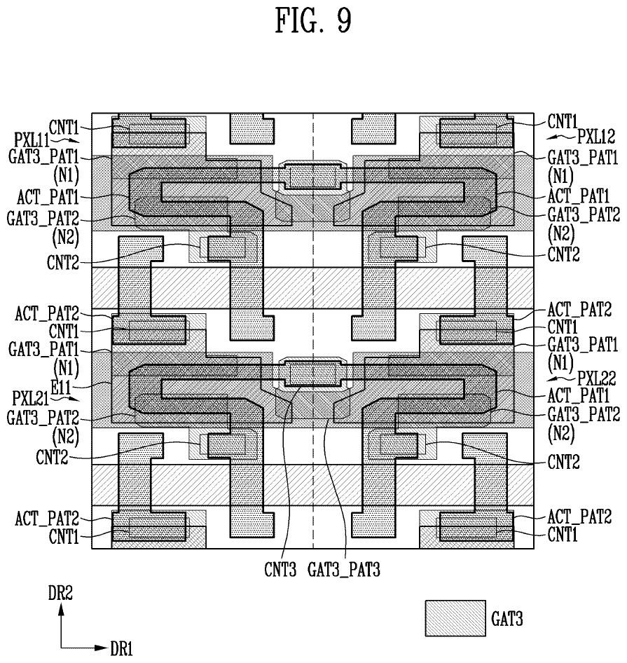

Referring to FIG. 9, the third gate electrode layer GAT3 may be positioned on the first to third contact holes CNT1 to CNT3.

The third gate electrode layer GAT3 may include a first gate electrode pattern GAT3_PAT1, a second gate electrode pattern GAT3_PAT2, and a third gate electrode pattern GTA3_PAT3.

The first gate electrode pattern GAT3_PAT1 may overlap the first contact hole CNT1 in a plan view. The first gate electrode pattern GAT3_PAT1 constitutes the first node N1, and may function as a connection electrode for electrically connecting the first electrode E11 of the storage capacitor Cst and the second active pattern ACT_PAT2 to each other.

The second gate electrode pattern GAT3_PAT2 may overlap the second contact hole CNT2 in a plan view. The second gate electrode pattern GAT3_PAT2 constitutes the second node N2 and may be connected to at least a part of the first active pattern ACT_PAT1.

The third gate electrode pattern GAT3_PAT3 may overlap the third contact hole CNT3 in a plan view. The third gate electrode pattern GAT3_PAT3 may function as a connection electrode for transmitting the above-described first power supply voltage ELVDD (see FIG. 2).

The third gate electrode layer GAT3 may include a metal. In an embodiment, for example, the third gate electrode layer GAT3 may include at least one of metals such as gold (Au), silver (Ag), aluminum (Al), molybdenum (Mo), chromium (Cr), titanium (Ti), nickel (Ni), neodymium (Nd), copper (Cu), tungsten (W), or an alloy thereof. According to an embodiment, the third gate electrode layer GAT3 may be defined by a single layer or multiple layers in which two or more of metals and alloys thereof are stacked.

At least one interlayer insulating layer may be disposed between the second gate electrode layer GAT2 and the third gate electrode layer GATE3. The interlayer insulating layer may include an inorganic insulator such as silicon oxide (SiO₂), silicon nitride (SiNₓ) (x is a positive number), silicon oxynitride (SiON), aluminum oxide (Al₂O₃), titanium oxide (TiO₂), tantalum oxide (Ta₂O₅), hafnium oxide (HfO₂), and/or zinc oxide (ZnOₓ). The zinc oxide may be zinc oxide (ZnO), and/or zinc peroxide (ZnO₂).

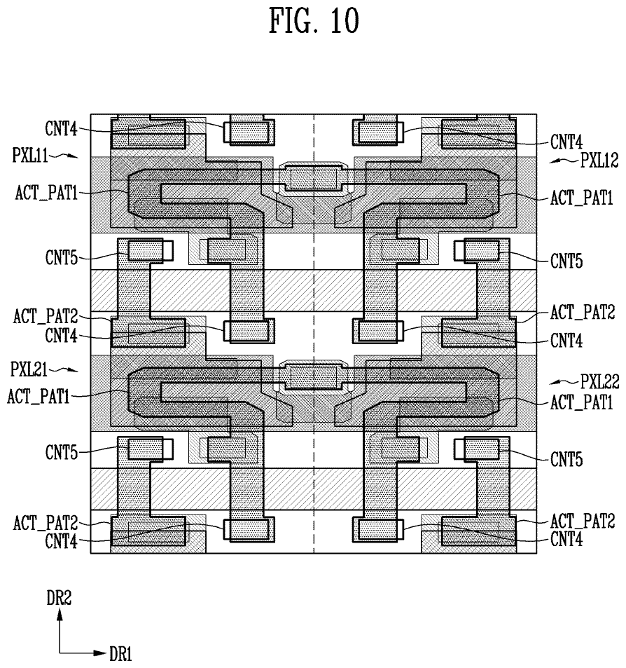

Referring to FIG. 10, a fourth contact hole CNT4 and a fifth contact hole CNT5 may be defined or formed on the third gate electrode layer GAT3. The fourth and fifth contact holes CNT4 and CNT5 may be formed by removing at least a part of the first via layer located on the third gate electrode layer GAT3.

The fourth contact hole CNT4 may expose at least a part of the first active pattern ACT_PAT1.

The fifth contact hole CNT5 may expose at least a part of the second active pattern ACT_PAT2.

The first via layer may include an inorganic insulating layer including an inorganic material and/or an organic insulating layer including an organic material. The inorganic insulating layer may include, for example, at least one of metal oxides such as silicon oxide (SiOₓ), silicon nitride (SiNₓ), silicon oxynitride (SiOₓN_{y}), and aluminum oxide (AlOₓ). The organic insulating layer may include, for example, at least one selected from an acrylic resin, an epoxy resin, a phenol resin, a polyamide resin, a polyimide resin, an unsaturated polyester resin, a polyphenylene ether resin, a poly-phenylene sulfide resin, and a benzocyclobutene resin.

According to an embodiment, the first via layer may include a same material as one of the interlayer insulating layers described above. However, embodiments of the disclosure are not limited thereto. According to embodiments, the first via layer may be provided as a single layer, or may be provided as multiple layers.

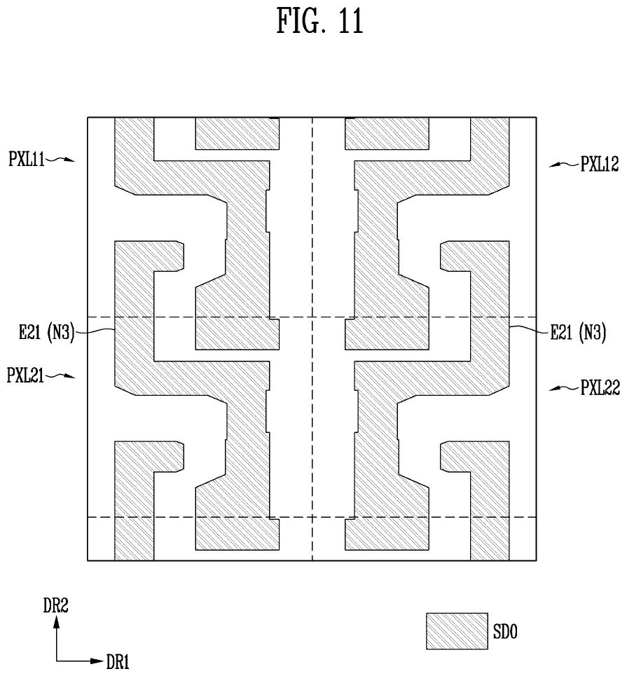

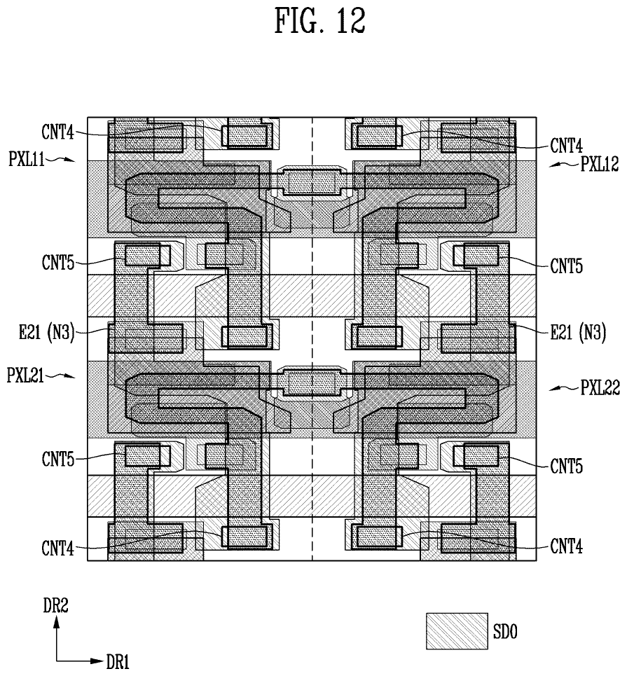

Referring to FIGS. 11 and 12, a base electrode layer SD0 may be disposed on the fourth and fifth contact holes CNT4 and CNT5.

The first electrode E21 of the hold capacitor Cpr (see FIG. 2) may be defined by the base electrode layer SD0.

The base electrode layer SD0 may overlap the fourth contact hole CNT4 and the fifth contact hole CNT5 in a plan view.

The base electrode layer SD0 may be defined by a single layer or multiple layers, each layer therein including at least one selected from molybdenum (Mo), aluminum (Al), chromium (Cr), gold (Au), titanium (Ti), nickel (Ni), neodymium (Nd), and copper (Cu), or an alloy thereof, but embodiments of the disclosure are not limited thereto.

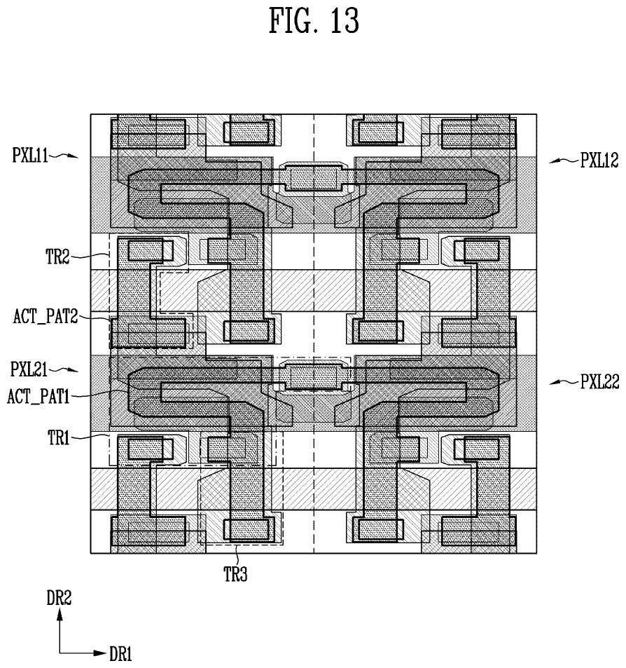

Referring to FIG. 13, first to third transistors TR1 to TR3 are illustrated based on the third pixel PXL21.

The semiconductor layer of the first transistor TR1 may be defined by a first active pattern ACT_PAT1. The semiconductor layer of the second transistor TR2 may defined by a second active pattern ACT_PAT2. The semiconductor layer of the third transistor TR3 may defined by a first active pattern ACT_PAT1.

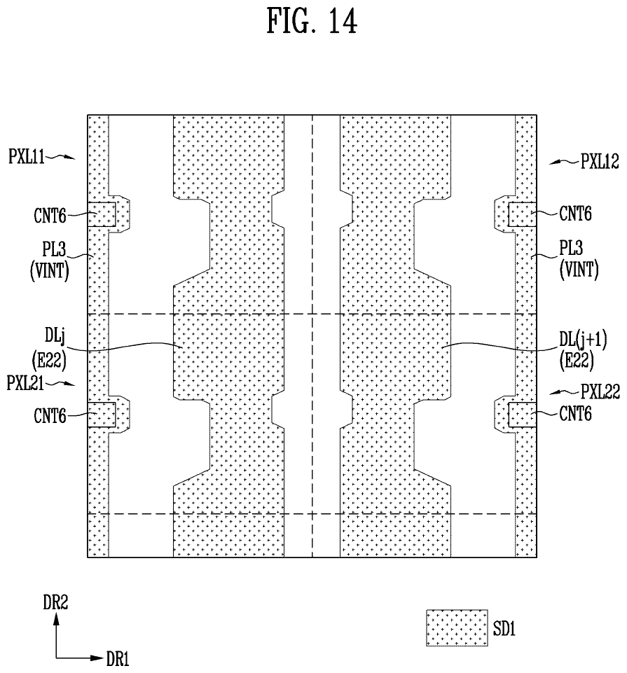

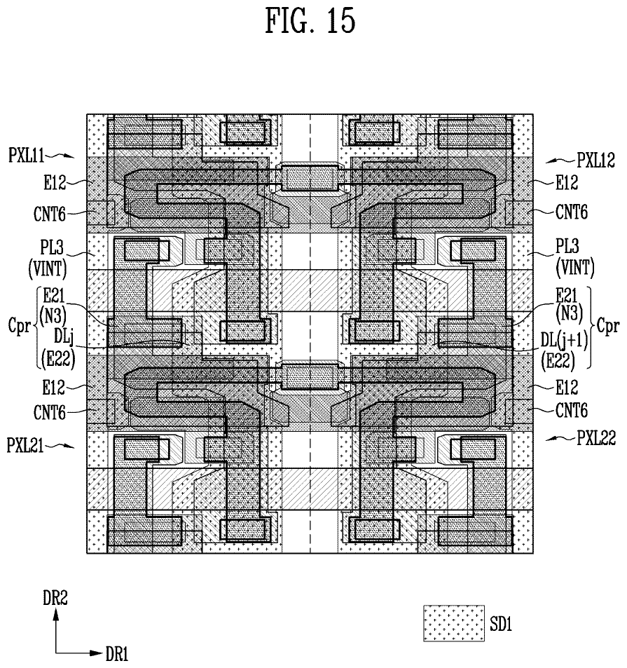

Referring to FIGS. 14 and 15, a first source-drain electrode layer SD1 may be positioned on the base electrode layer SD0.

A second via layer may be included between the base electrode layer SD0 and the first source-drain electrode layer SD1. The second via layer may include an inorganic insulating layer including an inorganic material and/or an organic insulating layer including an organic material. The inorganic insulating layer may include, for example, at least one of metal oxides such as silicon oxide (SiOₓ), silicon nitride (SiNₓ), silicon oxynitride (SiOₓN_{y}), and aluminum oxide (AlOₓ). The organic insulating layer may include, for example, at least one selected from an acrylic resin, an epoxy resin, a phenol resin, a polyamide resin, a polyimide resin, an unsaturated polyester resin, a polyphenylene ether resin, a poly-phenylene sulfide resin, and a benzocyclobutene resin.

Each of the data lines DLj and DL(j+1) and the third power line PL3 may be defined by the first source-drain electrode layer SD1.

The first source-drain electrode layer SD1 may be defined by a single layer or multiple layers, each layer therein including at least one selected from molybdenum (Mo), aluminum (Al), chromium (Cr), gold (Au), titanium (Ti), nickel (Ni), neodymium (Nd), and copper (Cu), or an alloy thereof, but embodiments of the disclosure are not limited thereto.

The data lines DLj and DL(j+1) may constitute the second electrode E22 of the hold capacitor Cpr. In an embodiment, for example, the j-th data line DLj may constitute the second electrode E22 in the hold capacitor Cpr of each of the first pixel PXL11 and the third pixel PXL21, respectively. The (j+1)-th data line DL(j+1) may constitute the second electrode E22 in the hold capacitor Cpr of each of the second pixel PXL12 and the fourth pixel PXL22, respectively.

The second electrode E22 of the hold capacitor Cpr may overlap the first electrode E21 in a plan view.

The third power line PL3 may be connected to the second electrode E12 of the storage capacitor Cst located below through the sixth contact hole CNT6. The sixth contact hole CNT6 may be formed by removing at least a part of the second via layer.

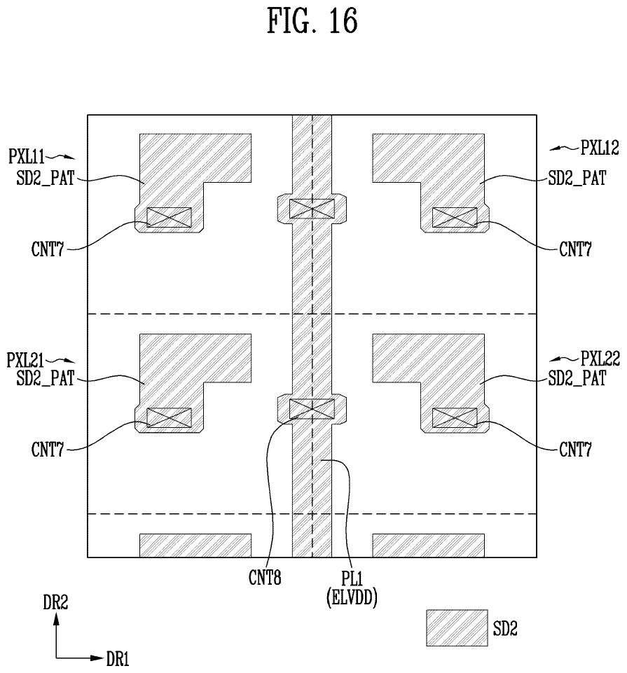

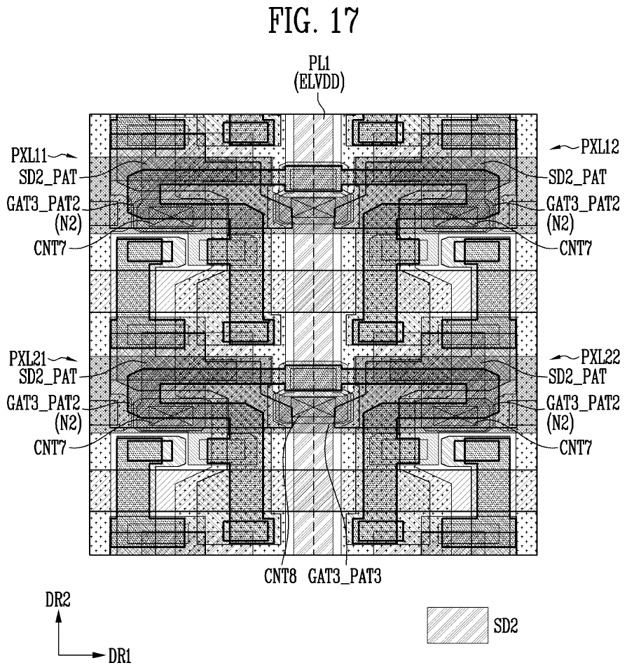

Referring to FIGS. 16 and 17, a second source-drain electrode layer SD2 may be positioned on the first source-drain electrode layer SD1.

The first power line PL1 may be defined by the second source-drain electrode layer SD2. The source-drain electrode pattern SD2_PAT may be defined by the second source-drain electrode layer SD2.

The second source-drain electrode layer SD2 may be formed as a single layer or multiple layers, each layer therein including at least one selected from molybdenum (Mo), aluminum (Al), chromium (Cr), gold (Au), titanium (Ti), nickel (Ni), neodymium (Nd), and copper (Cu), or an alloy thereof, but embodiments of the disclosure are not limited thereto.

The source-drain electrode pattern SD2_PAT may constitute the second node N2, and the source-drain electrode pattern SD2_PAT is connected to the second gate electrode pattern GAT3_PAT2 through the seventh contact hole CNT7.

The first power supply voltage ELVDD may be applied to the first power line PL1. The first power line PL1 may extend in the second direction DR2 as a whole in a boundary region between two pixels adjacent to each other in the first direction DR1. The first power line PL1 may be connected to the third gate electrode pattern GAT3_PAT3 located below through the eighth contact hole CNT8.

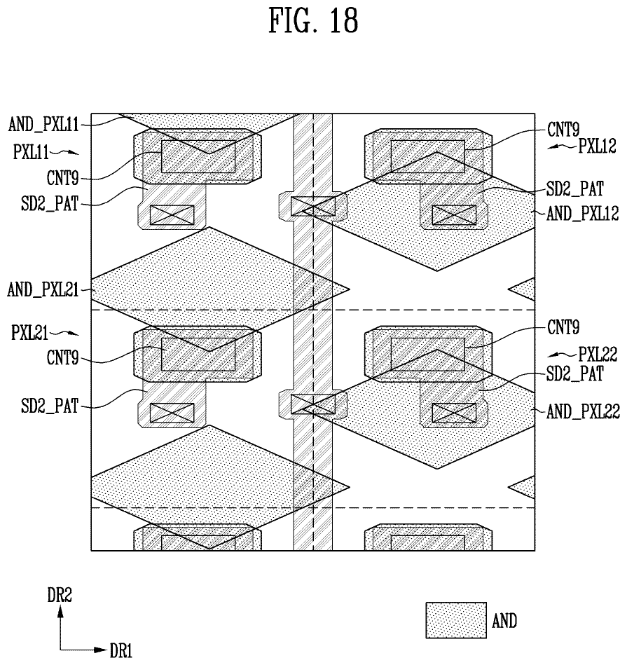

Referring to FIG. 18, an anode electrode layer AND may be disposed on the second source-drain electrode layer SD2.

The anode electrode layer AND may be connected to the source-drain electrode pattern SD2_PAT located below through the ninth contact hole CNT9. The first anode electrode AND_PXL11 may be located in the first pixel PXL11. The second anode electrode AND_PXL12 may be located in the second pixel PXL12. The third anode electrode AND_PXL21 may be located in the third pixel PXL21. The fourth anode electrode AND_PXL22 may be located in the fourth pixel PXL22.

The ninth contact hole CNT9 may be defined or formed in a region where at least a part of the third via layer located between the second source-drain electrode layer SD2 and the anode electrode layer AND is removed. The third via layer may include an inorganic insulating layer including an inorganic material and/or an organic insulating layer including an organic material. The inorganic insulating layer may include, for example, at least one of metal oxides such as silicon oxide (SiOₓ), silicon nitride (SiNₓ), silicon oxynitride (SiOₓN_{y}), and aluminum oxide (AlOₓ). The organic insulating layer may include, for example, at least one selected from an acrylic resin, an epoxy resin, a phenol resin, a polyamide resin, a polyimide resin, an unsaturated polyester resin, a polyphenylene ether resin, a poly-phenylene sulfide resin, and a benzocyclobutene resin.

The anode electrode layer AND may include an opaque conductive material capable of reflecting light. However, embodiments of the disclosure are not limited thereto. In embodiments, the anode electrode layer AND may include at least one of transparent conductive materials such as indium tin oxide (ITO), indium zinc oxide (IZO), zinc oxide (ZnO), indium gallium zinc oxide (IGZO), indium tin zinc oxide (ITZO). However, the material of the anode electrode layer AND is not limited thereto. In an embodiment, for example, the anode electrode layer AND may include titanium nitride.

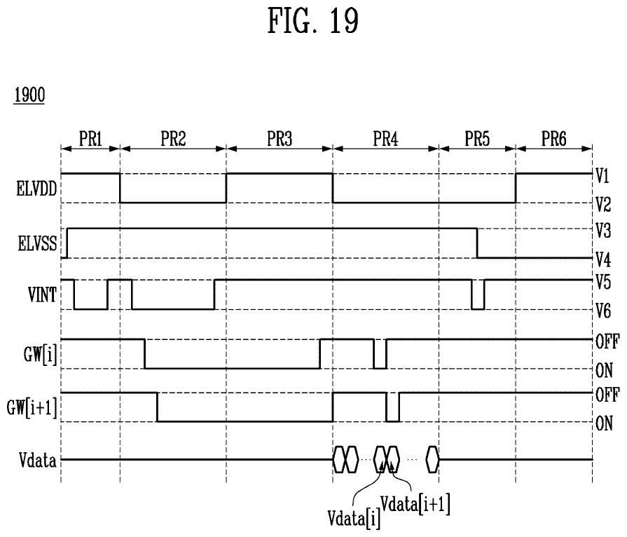

FIG. 19 is a signal timing diagram illustrating a method 1900 of driving a display device according to embodiments of the disclosure.

Referring to FIG. 19, a frame period of a method 1900 of driving a display device according to embodiments of the disclosure may include first to sixth periods PR1 to PR6.

In the first period PR1, the first power supply voltage ELVDD may have the first voltage V1. The second power supply voltage ELVSS may have a third power supply voltage V3. The third power supply voltage VINT may have a fifth voltage V5 or a sixth voltage V6. The i-th scan signal GW[i] may have an off level OFF. The (i+1)-th scan signal GW[i+1] may have an off level OFF. The data voltage Vdata may be in a state in which a constant voltage is applied, or may be in a high impedance state.

The first voltage V1 may be a high level voltage. The third voltage V3 may be a high level voltage. The fifth voltage V5 may be a high level voltage. The sixth voltage V6 may be a low level voltage. The off level OFF may be a high level voltage.

The first period PR1 may be referred to as an on-bias period.

In the second period PR2, the first power supply voltage ELVDD may have the second voltage V2. The second power supply voltage ELVSS may have a third voltage V3. The third power supply voltage VINT may have a fifth voltage V5 or a sixth voltage V6. The i-th scan signal GW[i] may transition from off level OFF to on level ON. The (i+1)-th scan signal GW[i+1] may transition from off level OFF to on level ON. The data voltage Vdata may be in a state in which a constant voltage is applied, or may be in a high impedance state.

The second voltage V2 may be a low level voltage. The third voltage V3 may be a high level voltage. The fifth voltage V5 may be a high level voltage. The sixth voltage V6 may be a low level voltage. The OFF level may be a high level voltage. The on level ON may be a low level voltage.

The second period PR2 may be referred to as the initialization period.

In the third period PR3, the first power supply voltage ELVDD may have the first voltage V1. The second power supply voltage ELVSS may have a third voltage V3. The third power supply voltage VINT may have a fifth voltage V5. The i-th scan signal GW[i] may have an on level ON. The (i+1)-th scan signal GW[i+1] may have an on level ON. The data voltage Vdata may be in a state in which a constant voltage is applied, or may be in a high impedance state.

The first voltage V1 may be a high level voltage. The third voltage V3 may be a high level voltage. The fifth voltage V5 may be a high-level voltage. The on level ON may be a low level voltage.

The third period PR3 may be referred to as the compensation period.

In the fourth period PR4, the first power supply voltage ELVDD may have the second voltage V2. The second power supply voltage ELVSS may have a third voltage V3. The third power supply voltage VINT may have a fifth voltage V5. The i-th scan signal GW[i] may have an on level ON. The (i+1)-th scan signal GW[i+1] may have an off level OFF. A signal for applying the data voltage Vdata to each of a plurality of pixel rows may be applied.

The second voltage V2 may be a low level voltage. The third voltage V3 may be a high level voltage. The fifth voltage V5 may be a high level voltage. The off level OFF may be a high level voltage. The on level ON may be a low level voltage.

In the data voltage Vdata, a signal written in the i-th pixel row may be referred to as “Vdata[i]”. A signal written in the (i+1)-th pixel row may be referred to as “Vdata[i+1]”.

The fourth period PR4 may be referred to as the data writing period.

In the fifth period PR5, the first power supply voltage ELVDD may have a second voltage V2. The second power supply voltage ELVSS may be lowered from the third voltage V3 to the fourth voltage V4. The third power supply voltage VINT may have a fifth voltage V5 or a sixth voltage V6. The i-th scan signal GW[i] may have an off level OFF. The (i+1)-th scan signal GW[i+1] may have an off level OFF. The data voltage Vdata may be in a state in which a constant voltage is applied, or may be in a high impedance state.

The second voltage V2 may be a low level voltage. The third voltage V3 may be a high level voltage. The fourth voltage V4 may be a low level voltage. The fifth voltage V5 may be a high-level voltage. The sixth voltage V6 may be a low level voltage. The off level OFF may be a high level voltage.

The fifth period PR5 may be referred to as a margin period.

In the sixth period PR6, the first power supply voltage ELVDD may have the first voltage V1. The second power supply voltage ELVSS may have a fourth voltage V4. The third power supply voltage VINT may have a fifth voltage V5. The i-th scan signal GW[i] may have an off level OFF. The (i+1)-th scan signal GW[i+1] may have an off level OFF. The data voltage Vdata may be in a state in which a constant voltage is applied, or may be in a high impedance state.

The first voltage V1 may be a high level voltage. The fourth voltage V4 may be a low level voltage. The fifth voltage V5 may be a high-level voltage. The off level OFF may be a high level voltage.

The sixth period PR6 may be referred to as the light-emitting period.

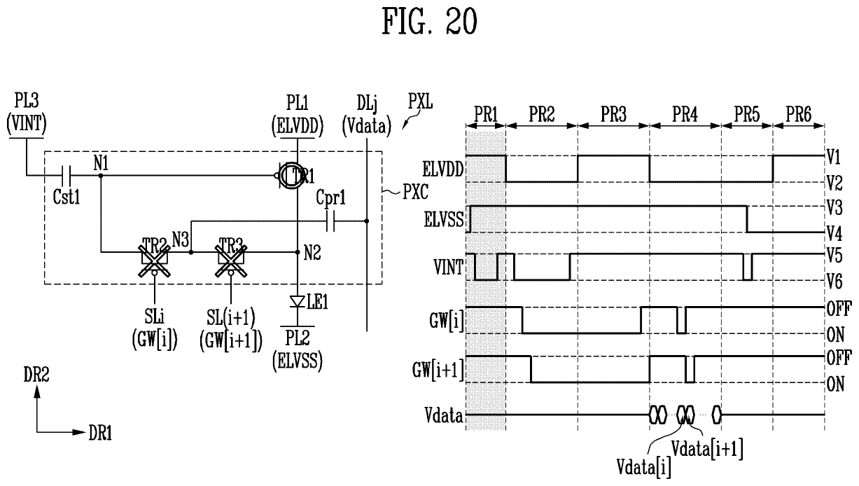

FIGS. 20 to 26 are diagrams illustrating a method 1900 of driving the display device according to FIG. 19 with the pixel PXL of FIG. 2.

Referring to FIG. 20, an operation of the pixel PXL in the first period PR1 is shown.

The second transistor TR2 and the third transistor TR3 may be turned off during the first period PR1. The i-th scan signal GW[i] may have an off level OFF. The (i+1)-th scan signal GW[i+1] may have an off level OFF.

The first power supply voltage ELVDD may have a first voltage V1. The second power supply voltage ELVSS may have a third voltage V3. The third power supply voltage VINT may decrease from the fifth voltage V5 to the sixth voltage V6 and then increase again to the fifth voltage V5. As a result, the voltage of the first node N1 may similarly decrease and then increase again. Accordingly, an on-bias voltage of a turn-on level may be applied to the first transistor TR1, but the second power supply voltage ELVSS may have a third voltage V3 of a high level, such that the driving current may not flow through the first light-emitting element LE1 during the first period PR1.

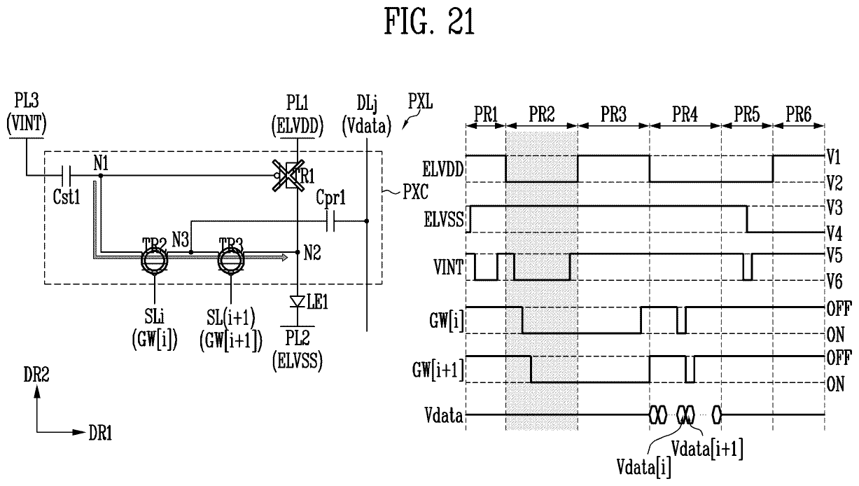

Referring to FIG. 21, an operation of the pixel PXL in the second period PR2 is shown.

During the second period PR2, the second transistor TR2 may be turned on. The i-th scan signal GW[i] may have an on level ON.

In the second period PR2, the third transistor TR3 may be turned on. The (i+1)-th scan signal GW[i+1] may have an on level ON.

The first node N1, the second node N2, and the third node N3 may be electrically connected to each other. As the voltage level of the third power line PL3 changes from the fifth voltage V5 to the sixth voltage V6, the voltages of the first to third nodes N1 to N3 also change and may be initialized.

The first power supply voltage ELVDD may have a second voltage V2. The second power supply voltage ELVSS may have a third voltage V3. Accordingly, the driving current may not flow from the first transistor TR1 in the direction of the first light-emitting element LE1 during the second period PR2.

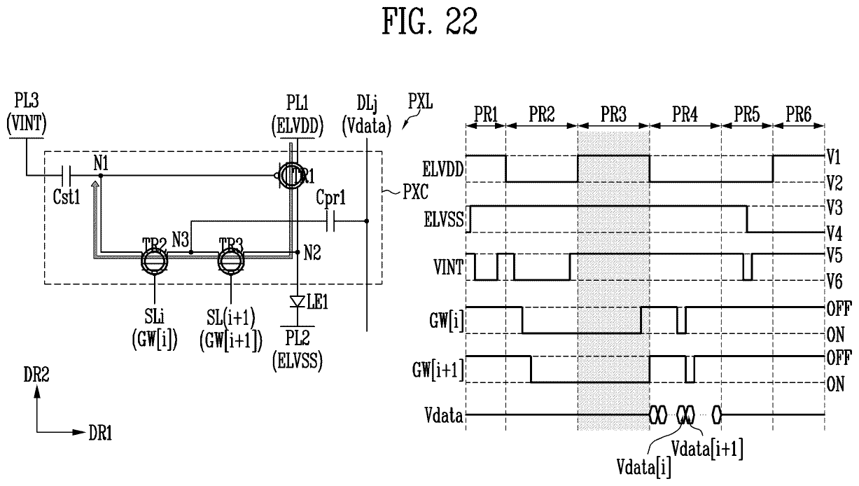

Referring to FIG. 22, an operation of the pixel PXL in the third period PR3 is shown.

During the third period PR3, the second transistor TR2 may be turned on. The first scan signal GW[i] may have an on level ON.

During the third period PR3, the third transistor TR3 may be turned on. The (i+1)-th scan signal GW[i+1] may have an on level ON.

The first power supply voltage ELVDD may have a first voltage V1. Accordingly, the first transistor TR1 may be diode-connected during the third period PR3. Accordingly, a change in a characteristic value of the first transistor TR1 (for example, a change in the threshold voltage of the first transistor TR1) may be compensated during the third period PR3.

The second power supply voltage ELVSS may have a third voltage V3. Accordingly, the driving current may not flow from the first transistor TR1 in the direction of the light-emitting element LE during the third period PR3.

The third power supply voltage VINT may have a fifth voltage V5 during the third period PR3.

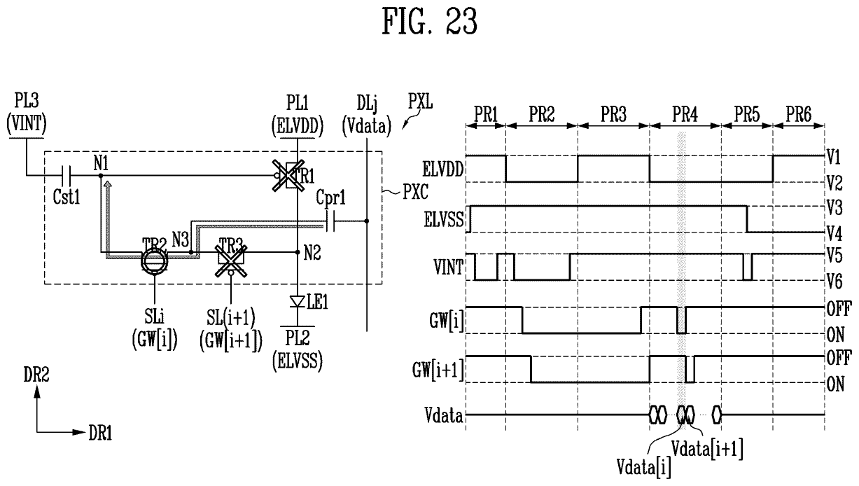

Referring to FIG. 23, an operation of the pixel PXL in at least a part of the fourth period PR4 is shown.

Referring to FIG. 23, during at least a part of the fourth period PR4, the data voltage Vdata[i] input to the pixel PXL may be applied to the j-th data line DLj.

In at least a part of the fourth period PR4, the second transistor TR2 may be turned on. The i-th scan signal GW[i] at the turn-on level may be applied to the i-th scan line SLi. Due to the coupling effect of the hold capacitor Cpr, the voltage of the third node N3 may fluctuate to a magnitude corresponding to the data voltage Vdata[i]. The first node N1 is electrically connected to the third node N3, and a voltage corresponding to the data voltage Vdata[i] may be applied to the first node N1 during at least a part of the fourth period PR4.

The first transistor TR1 and the third transistor TR3 may be turned off during at least a part of the fourth period PR4.

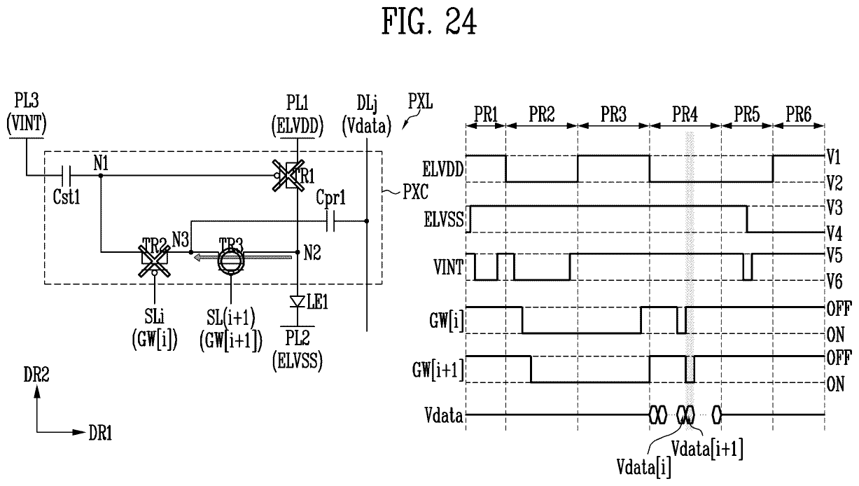

Referring to FIG. 24, an operation of the pixel PXL in the remaining part of the fourth period PR4 is shown.

Referring to FIG. 24, in the remaining part of the fourth period PR4, the data voltage Vdata[i+1] input to the following pixel may be applied to the j-th data line DLj.

In the remaining part of the fourth period PR4, the third transistor TR3 may be turned on. The (i+1)-th scan signal GW[i+1] at the turn-on level may be applied to the (i+1)-th scan line SL(i+1).

A voltage corresponding to the data voltage Vdata[i+1] may be applied to the third node N3 during the remaining part of the fourth period PR4. The third node N3 and the second node N2 may be electrically connected to each other. During the remaining part of the fourth period PR4, the second transistor TR2 remains in the turn-off state, and the voltage fluctuation of the second and third nodes N2 and N3 is not reflected in the first node N1.

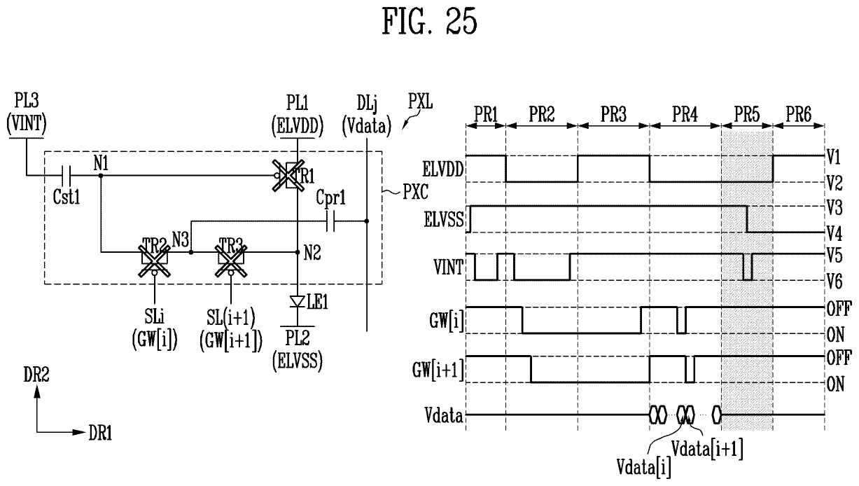

Referring to FIG. 25, an operation of the pixel PXL in the fifth period PR5 is shown.

In the fifth period PR5, the first power supply voltage ELVDD may have a second level V2. The second power supply voltage ELVSS may be lowered from the third voltage V3 to the fourth voltage V4.

In the fifth period PR5, the third power supply voltage VINT may decrease from the fifth voltage V5 to the sixth voltage V6 and then rise back to the fifth voltage, around the time when the second power supply voltage ELVSS decreases from the third voltage V3 to the fourth voltage V4.

All of the first to third transistors TR1 to TR3 may be turned off during the fifth period PR5.

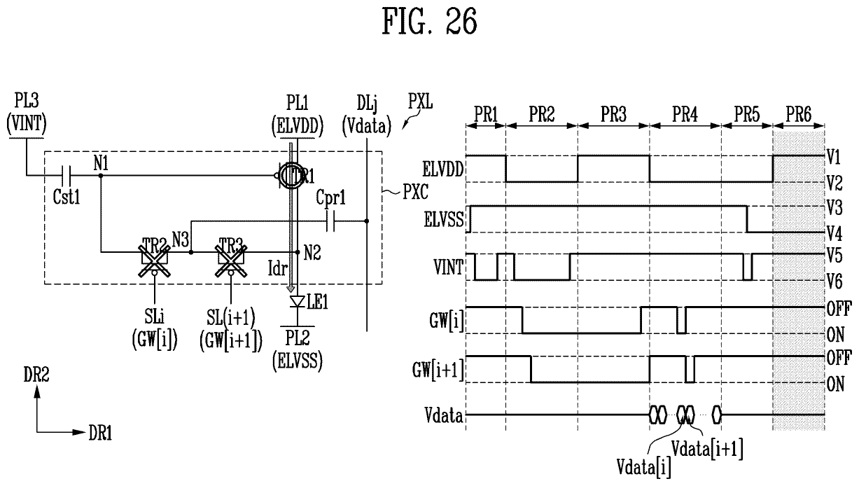

Referring to FIG. 26, an operation of the pixel PXL in the sixth period PR6 is shown.

In the sixth period PR6, the first power supply voltage ELVDD may have a first voltage V1. The second power supply voltage ELVSS may have a fourth voltage V4. Accordingly, the first transistor TR1 may provide a driving current Idr having a magnitude corresponding to the voltage of the first node N1 during the sixth period PR6.

in the sixth period PR6, the second transistor TR2 and the third transistor TR3 may be turned off.

According to embodiments of the disclosure, the configuration of the above-described scan driving circuit 130 (see FIG. 1) may be simplified. Thereby, the area of the non-display area NDA (see FIG. 1) can be reduced.

According to embodiments of the disclosure, the configuration of the pixel circuit PXC may be simplified to increase the degree of integration of the pixel PXL. Thereby, a display device 100 (see FIG. 1) having an increased resolution can be provided.

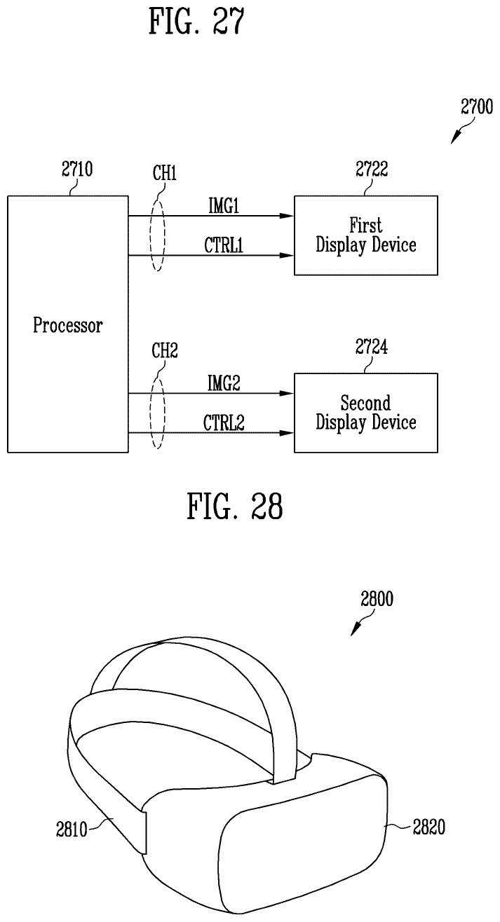

FIG. 27 is a diagram illustrating an embodiment of a display system 2700 according to embodiments of the disclosure.

Referring to FIG. 27, an embodiment of the display system 2700 may include a processor 2710 and one or more display devices 2722 and 2724. The display system 2700 of FIG. 27 may be applied to the electronic device DS of FIG. 1.

The processor 2710 may perform various tasks and calculations. In embodiments, the processor 2710 may include an application processor (AP), a graphics processing unit (GPU), a microprocessor, a central processing unit (CPU), or the like. The processor 2710 may be connected to other components of the display system 2700 through a bus system to control them.

In FIG. 27, an embodiment of the display system 2700 including first and second display devices 2722 and 2724 is shown. The processor 2710 may be connected to the first display device 2722 through a first channel CH1, and may be connected to a second display device 2724 through a second channel CH2.

Through the first channel CH1, the processor 2710 may transmit the first image data IMG1 and the first control signal CTRL1 to the first display device 2722. The first display device 2722 may display an image based on the first image data IMG1 and the first control signal CTRL1. The first display device 2722 may be configured similarly to the display device 100 described with reference to FIG. 1. In an embodiment, the first image data IMG1 and the first control signal CTRL1 may be provided as the first image data DATA1 and the control signal CS of FIG. 1, respectively.

Through the second channel CH2, the processor 2710 may transmit the second image data IMG2 and the second control signal CTRL2 to the second display device 2724. The second display device 2724 may display an image based on the second image data IMG2 and the second control signal CTRL2. The second display device 2724 may be configured similarly to the display device 100 described with reference to FIG. 1. In an embodiment, the second image data IMG2 and the second control signal CTRL2 may be provided as the first image data DATA1 and the control signal CS of FIG. 1, respectively.

The processor 2710 may be configured similarly to the host HST described with reference to FIG. 1.

In an embodiment, the display system 2700 may include a computing system that provides image display capabilities such as portable computer, mobile phone, smart phone, tablet personal computer, smart watch, watch phone, portable multimedia player (PMP), navigation, ultra-mobile personal computer (UMPC), and the like. In addition, the display system 2700 may include a head-mounted display device, a virtual reality device, a mixed reality device, or an augmented reality device.

FIG. 28 is a diagram showing an application example of the display system 2700 of FIG. 27.

Referring to FIG. 28, the display system 2700 of FIG. 27 may be applied to the head-mounted display device 2800. The head-mounted display device 2800 may be a wearable electronic device that can be worn on the user's head.

In an embodiment, the head-mounted display device 2800 may include a head-mounted band 2810 and a display device storage case 2820. The head-mounted band 2810 may be connected to the display device housing case 2820. The head-mounted band 2810 may include a horizontal band and/or a vertical band for fixing the head-mounted display device 2800 to the user's head. The horizontal band may be configured to surround a side of the user's head, and the vertical band may be configured so as to surround an upper portion of a user's head. However, embodiments are not so limited. In an embodiment, for example, the head-mounted band 2810 may be implemented in the form of an eyeglass frame, a helmet, or the like.

The display device storage case 2820 may store the first and second display devices 2722 and 2724 of FIG. 27. The display device storage case 2820 may further store the processor 2710 of FIG. 27.

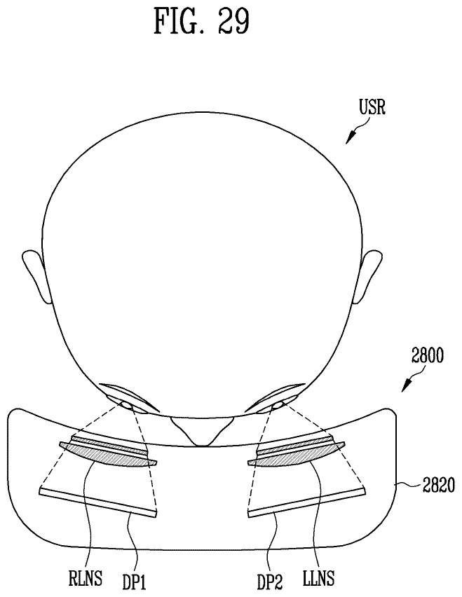

FIG. 29 is a diagram showing a head-mounted display device 2800 worn on a user USR.

Referring to FIG. 29, a first display panel DP1 of a first display device 2722 (see FIG. 27) and a second display panel DP2 of a second display device 2724 (see FIG. 29) may be disposed in the head-mounted display device 2800. The head-mounted display device 2800 may further include one or more lenses. For example, the head-mounted display device 2800 may include a left eye lens LLNS and a right eye lens RLNS.

In the display device storage case 2820, the right eye lens RLNS may be disposed between the first display panel DP1 and the user's right eye. In the display device storage case 2820, the left eye lens LLNS may be disposed between the second display panel DP2 and the user's left eye.

The image output from the first display panel DP1 may be displayed on the right eye of the user USR through the right eye lens RLNS. The right eye lens RLNS may refract the light emitted from the first display panel DP1 toward the right eye of the user USR. The right eye lens RLNS may perform an optical function for adjusting the viewing distance between the first display panel DP1 and the user's right eye.

The image output from the second display panel DP2 may be displayed on the left eye of the user USR through the left eye lens LLNS. The left eye lens LLNS may refract the light emitted from the second display panel DP2 toward the left eye of the user USR. The left eye lens LLNS may perform an optical function for adjusting the viewing distance between the second display panel DP2 and the user's left eye.

In embodiments, each of the right eye lens RLNS and the left eye lens LLNS may include an optical lens having a pancake-shaped cross-section. In embodiments, each of the right eye lens RLNS and the left eye lens LLNS may include a multi-channel lens including sub-regions having different optical properties. In such an embodiment, each of the first and second display panels DP1 and DP2 may output images corresponding to sub-areas of the multi-channel lens, and the output images may be shown to the user USR through the corresponding sub-areas, respectively.

According to a pixel, a display device including the pixel, and an electronic device including the pixel according to embodiments of the disclosure, the degree of integration of a pixel may be improved.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel comprising:
a first transistor including a gate electrode connected to a first node, wherein the first transistor is connected between a first power line and a second node;
a second transistor including a gate electrode connected to an i-th scan line, wherein the second transistor is connected between the first node and a third node, and i is an integer equal to or greater than 1;
a third transistor including a gate electrode connected to a j-th scan line, wherein the third transistor is connected between the second node and the third node, and j is an integer different from i;
a light-emitting element connected between the second node and a second power line;
a first capacitor including a first electrode connected to the first node and a second electrode connected to a third power line; and
a second capacitor including a first electrode connected to the third node and a second electrode connected to a data line.

2. The pixel of claim 1, wherein j is an integer greater than i.

3. The pixel of claim 2, wherein j is equal to (i+1).

4. The pixel of claim 1, wherein the first to third transistors are P-type transistors.

5. The pixel of claim 1, wherein:
a first power supply voltage is applied to the first power line;
a second power supply voltage is applied to the second power line;
a third power supply voltage is applied to the third power line;
an i-th scan signal is applied to the i-th scan line;
an (i+1)-th scan signal is applied to the j-th scan line; and
each of the first to third power supply voltages has a varying voltage level.

6. The pixel of claim 5, wherein, in a first period of a frame period:
the first power supply voltage has a first voltage at a high level;
the second power supply voltage has a third voltage at a high level;
the third power supply voltage has a sixth voltage at a low level;
the i-th scan signal has an off level; and
the (i+1)-th scan signal has the off level.

7. The pixel of claim 5, wherein, in a second period of a frame period:
the first power supply voltage has a second voltage at a low level;
the second power supply voltage has a third voltage at a high level;
the third power supply voltage has a sixth voltage at a low level;
the i-th scan signal transitions to the on level;
the (i+1)-th scan signal transitions to the on level; and
the first to third nodes are electrically connected to each other.

8. The pixel of claim 5, wherein, in a third period of a frame period:
the first power supply voltage has a first voltage at a high level;
the second power supply voltage has a third voltage at a high level;
the third power supply voltage has a fifth voltage at a high level;
the i-th scan signal has an on level;
the (i+1)-th scan signal has the on level; and
the first power line is electrically connected to the first node through the second and third nodes.

9. The pixel of claim 5, wherein, in at least a part of a fourth period of a frame period:
the first power supply voltage has a second voltage at a low level;
the second power supply voltage has a third voltage at a high level;
the third power supply voltage has a fifth voltage at a high level;
the i-th scan signal has an on level;
the (i+1)-th scan signal has an off level; and
the first node and the third node are electrically connected to each other.

10. The pixel of claim 9, wherein, in a remaining part of the fourth period of the frame period:
the first power supply voltage has the second voltage;
the second power supply voltage has the third voltage;
the third power supply voltage has the fifth voltage;
the i-th scan signal has the off level;
the (i+1)-th scan signal has the on level; and
the second node and the third node are electrically connected to each other.

11. The pixel of claim 5, wherein, in a fifth period of a frame period:
the first power supply voltage has a second voltage at a low level;
the second power supply voltage transitions to a fourth voltage at a low level;
the third power supply voltage transitions to a sixth voltage at a low level;
the i-th scan signal has an off level; and
the (i+1)-th scan signal has the off level.

12. The pixel of claim 5, wherein, in a sixth period of a frame period:
the first power supply voltage has a first voltage at a high level;
the second power supply voltage has a fourth voltage at a low level;
the third power supply voltage has a fifth voltage at a high level;
the i-th scan signal has an off level;
the (i+1)-th scan signal has the off level; and
a driving current flows through the light-emitting element.

13. The pixel of claim 1, wherein semiconductor layers of the first transistor and the third transistor are defined by a first active pattern, and
wherein a semiconductor layer of the second transistor is defined by a second active pattern spaced apart from the first active pattern.

14. A display device comprising:
a display panel comprising a plurality of pixels a plurality of scan lines connected to the plurality of pixels, and a plurality of data lines connected to the plurality of pixels;
a scan driving circuit which supplies a scan signal to the plurality of scan lines; and
a data driving circuit which supplies a data voltage to the plurality of data lines,
wherein a first pixel of the plurality of pixels is connected to an i-th scan line of the plurality of scan lines, an (i+1)-th scan line of the plurality of scan lines, and a j-th data line of the plurality of data lines,
wherein i is an integer equal to or greater than 1, and j is an integer equal to or greater than 1,
wherein a second pixel of the plurality of pixels is connected to the i-th scan line, the (i+1)-th scan line, and a (j+1)-th data line of the plurality of data lines,
wherein a third pixel of the plurality of pixels is connected to the (i+1)-th scan line, the (i+2)-th scan line, and the j-th data line,
wherein a fourth pixel of the plurality of pixels is connected to the (i+1)-th scan line, the (i+2)-th scan line, and the (j+1)-th data line,
wherein the first pixel and the second pixel receive corresponding data voltages in response to a scan signal supplied to the i-th scan line, and
wherein the third pixel and the fourth pixel receive corresponding data voltages in response to a scan signal supplied to the (i+1)-th scan line.

15. The display device of claim 14, wherein the first pixel includes:
a first transistor including a gate electrode connected to a first node, wherein the first transistor is connected between a first power line and a second node;
a second transistor including a gate electrode connected to the i-th scan line, wherein the second transistor is connected between the first node and a third node;
a third transistor including a gate electrode connected to the (i+1)-th scan line, wherein the third transistor is connected between the second node and the third node;
a light-emitting element connected between the second node and a second power line;
a first capacitor including a first electrode connected to the first node and a second electrode connected to a third power line; and
a second capacitor including a first electrode connected to the third node and a second electrode connected to the j-th data line.

16. An electronic device comprising:
a host which provides input image data; and
a display device comprising a plurality of pixels for displaying an image based on the input image data, and a plurality of scan lines connected to the plurality of pixels,
wherein a pixel of the plurality of pixels comprises:
a first transistor comprising a gate electrode connected to a first node, wherein the first transistor is connected between a first power line and a second node;
a second transistor including a gate electrode connected to an i-th scan line of the plurality of scan lines, wherein the second transistor is connected between the first node and a third node, and i is an integer equal to or greater than 1;
a third transistor including a gate electrode connected to an (i+1)-th scan line of the plurality of scan lines, wherein the third transistor is connected between the second node and the third node;
a light-emitting element connected between the second node and a second power line;
a first capacitor including a first electrode connected to the first node and a second electrode connected to a third power line; and
a second capacitor including a first electrode connected to the third node and a second electrode connected to a data line.
